(19) United States
(12) Patent Application Publication
(10) Pub. No.: US 2023/0158431 A1
(43) Pub. Date: May 25, 2023

(54) Soft frame filter element and preparing method thereof

(71) Applicant: Dongguan AIR Guard Filter Manufacturing Co., Ltd, Dongguan (CN)

(72) Inventor: Wu Zhang, Dongguan (CN)

(21) Appl. No.: 17/653,257

(22) Filed: Mar. 2, 2022

(30) Foreign Application Priority Data
Nov. 25, 2021 (CN) 202111412196.1

(51) Int. Cl. B01D 46/00; B01D 46/24

(52) U.S. Cl. CPC B01D 46/0005; B01D 46/0001; B01D 46/24

(57) ABSTRACT

A soft frame filter element and a preparing method thereof. The soft frame filter element comprises a cylindrical filter element body, a soft lower frame and -a soft upper frame. The cylindrical filter element body has a lower edge and an upper edge, and a hollow structure is formed in the center of the cylindrical filter element body. The soft lower border wraps the lower edge. The soft upper border wraps the upper edge. Both the soft lower frame and the soft upper frame can be compressed to reduce the hollow structure, so as to reduce its volume, so that, more products can be placed in the same area, reducing the packaging cost and transporting cost.

### TECHNICAL FIELD

The present invention relates to filter element technical field, and more particularly, to a soft frame filter element and a preparing method thereof.

### BACKGROUND

The filter element is generally composed of a frame and a filter element body fixed on an inner side of the frame. The frame of the filter element in the prior art is mostly paper frame or plastic frame, and the firames of these materials are hard frames. Although these frames can support the filter element, they also bring some defects. For example, after the hard frames are applied to the cylindrical filter element, the central part of the cylindrical filter element is hollow, occupies a lot of space, and has high packaging and transporting costs.

### SUMMARY

The object of the invention is to provide a soft frame filter element and a preparing method thereof, which aims to solve the technical problems that the large space occupation and inconvenient transportation of the hard frame filter element in the prior art.

In order to achieve the aforementioned object, the present invention provides a soft frame filter element, which includes a cylindrical filter element body, a soft lower frame and a soft upper frame.

The cylindrical filter element body has a lower edge and an upper edge, and a hollow structure is formed in a center of the cylindrical filter element body.

The soft lower frame wraps the lower edge.

The soft upper frame wraps the upper edge; the soft lower frame and the soft upper frame can be compressed to reduce the hollow structure.

Optionally, the cylindrical filter element body is folded by a sheet of filter sheet, a plurality of folding edges are formed on the cylindrical filter element body, and the plurality of the folding edges are arranged along the axial direction of the cylindrical filter element body; the cylindrical filter element body can be folded along the folding edges to reduce the hollow structure.

Optionally, a circle of upper containing groove is arranged along the circumferential direction of the soft upper frame, the upper containing groove is provided with a first peripheral edge, the first peripheral edge is provided with an upper wrapping edge, the upper edge is embedded in the upper containing groove, and the upper edge is wrapped in at least one upper wrapping edge.

Optionally, a circle of lower containing groove is arranged along the circumferential direction of the soft lower frame, the lower containing groove is provided with a second peripheral edge, the second peripheral edge is provided with a lower wrapping edge, the lower edge is embedded in the lower containing groove, and the lower edge is wrapped in at least one lower wrapping edge.

Optionally, the cylindrical filter element body is in a cylindrical shape or an elliptical cylinder shape.

Optionally, the soft lower frame and/or the soft upper frame are foamed polyurethane frames.

In order to achieve the aforementioned object, the present invention provides a preparing method of the above soft frame filter element, which includes the following steps:

S1. preparing the cylindrical filter element body: folding a sheet of filter sheet into an annular cylindrical filter element body; placing the lower edge of the cylindrical filter element body in a lower mold and placing the upper edge of the cylindrical filter element body in an upper mold;

S2. preparing soft lower frame and soft upper frame: injecting the polyurethane raw material into the upper mold and the lower mold, the soft lower frame and the soft upper frame are made respectively after foaming polyurethane raw material;

S3. preparing soft frame filter element: combining the soft lower frame with the lower edge of the cylindrical filter element body, and combining the soft upper frame with the upper edge of the cylindrical filter element body, and the soft frame filter element is obtained.

Optionally, the polyurethane raw material contains the following mass percentages of components: 38%-42% of isocyanate, 13%-17% of diethanolamine, 6%-8% of crosslinking agent, 2%-4% of silicone foam stabilizer and 34%-36% of triethylene diamine.

Optionally, the polyurethane raw material contains the following mass percentages of components: 39%-41% of isocyanate, 14%-16% of diethanolamine, 6%-8% of crosslinking agent, 2%-4% of silicone foam stabilizer and 34%-36% of triethylene diamine.

One or more of the technical schemes of the soft frame filter element and its preparating method provided in the embodiments of the invention have at least one of the following technical effects:

1. The soft lower frame and the soft upper frame of the soft frame filter element can be compressed to reduce the hollow structure in the center of the cylindrical filter element body, thereby reducing its volume, so that more products can be placed in the same area, and reduce the packaging costs and transporting costs.

2. The soft lower frame and the soft upper frame have sealing effect, can replace the sealing parts and simplify the installation structure.

3. The preparing method of the soft frame filter element is simpler than that of the hard frame filter element, with higher producing, efficiency and lower producing cost.

### BRIEF DESCRIPTION OF THE DRAWINGS

In order to better illustrate the technical scheme in the embodiment of the invention, the following will give a brief description of the drawings to be used in the embodiments or the prior art. It is obvious that the drawings in the following description arc only some embodiments of the invention, and for those of ordinary skill in the art, other drawings can be obtained on the basis of the drawings without creative effort.

FIG. 1 is a front elevation view of a soft frame filter element according to an embodiment in the present invention.

FIG. 2 is a top plan view of a soft frame filter element according to an embodiment in the present invention.

FIG. 3 is a bottom plan view of a soft frame filter element according to an embodiment in the present invention.

FIG. 4 is another structural diagram of a soft frame filter element according to an embodiment in the present invention.

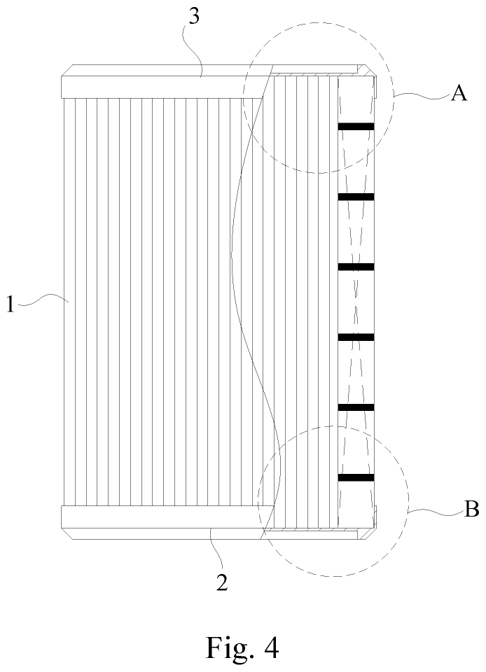

FIG. 5 is an enlarged view of area A shown in FIG. 4.

FIG. 6 is an enlarged view of area B shown in FIG. 4.

### DETAILED DESCRIPTION OF EMBODIMENTS

The embodiments in the present invention are described in detail below, and examples of the embodiments are shown in the drawings where the same or similar labels from beginning to end represent the same or similar elements or elements with the same or similar functions. The embodiments described below by reference to the drawings are exemplary and designed to explain the embodiments of the invention and cannot be understood as limitations on the invention.

In the description of the embodiment of the invention, it should be understood that if there are directional indications in the embodiment of the invention, such as “up”, “down”, “left” “right”, “front”, “back”, “inner” and “outer”, the azimuth or position relationship is based on the azimuth or position relationship shown in the figures, it is only for the convenience of describing the embodiment of the invention and simplifying the description, rather than indicating or implying that the device or element must have a specific orientation, be constructed and operated in a specific orientation, it cannot be understood as a limitation of the present invention.

In addition, the terms “first” and “second” are only used for descriptive purposes and cannot be understood as indicating or implying relative importance or implicitly indicating the number of indicated technical features. Thus, the features defining “first” and “second” may explicitly or implicitly include one or more of the features. In the description of embodiments of the present invention, “multiple” means two or more, unless otherwise specifically defined.

In the embodiment of the invention, unless otherwise specified and limited, if there are terms such as “install”, “joint ”, “connect” and “fix” , it should be understood in a broad sense. For example, it can be fixed connection, removable connection, or integrated; It can be mechanical connection or electrical connection; It can be directly connected or indirectly connected through an inteimediate medium. It can be the connection within two elements or the interaction relationship between two elements. For those of ordinary skill in the art, the specific meaning of the above terms in the embodiments of the invention can be understood according to the specific situation.

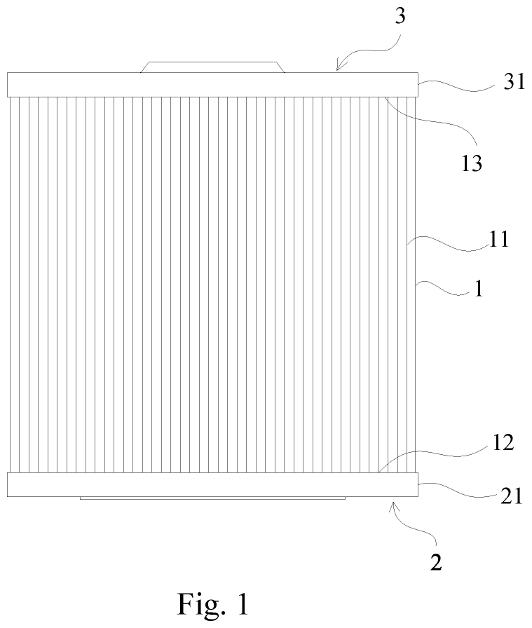

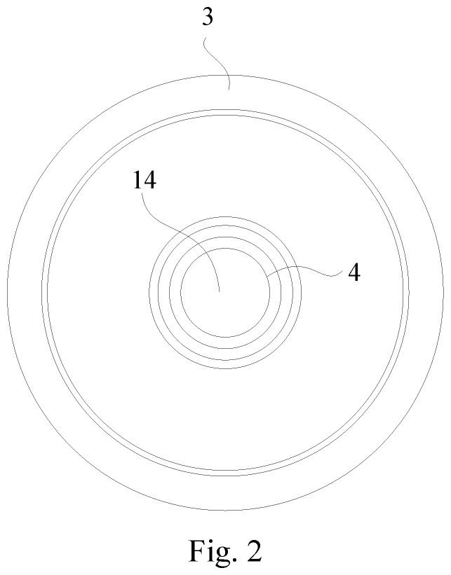

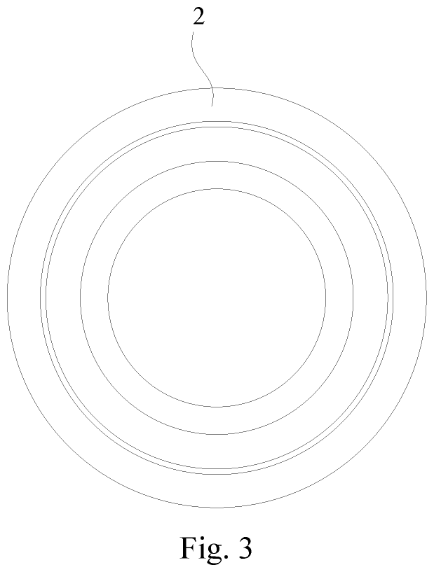

In embodiments of the invention, referring to FIG. 1 to FIG. 3, a soft frame filter element includes a cylindrical filter element body 1, a soft lower frame 2 and a soft upper frame 3. The cylindrical filter element body 1 has a lower edge 12 and an upper edge 13, and a hollow structure 14 is formed in the center of the cylindrical filter element body 1. During working, air flows into the hollow structure 14 from the outside of the cylindrical filter element body 1. The air is filtered when passing through the cylindrical filter element body 1, and the hollow structure 14 is communicated with an air outlet of an filtering device. Generally, an exhaust of the filtering device is communicated with a through hole arranged on the soft lower frame 2 or the soft upper frame 3.

The soft lower frame 2 wraps the lower edge 12, the soft upper frame 3 wraps the upper edge 13. The soft lower frame 2 and the soft upper frame 3 can be compressed to reduce the volume of the hollow structure 14. Specifically, the soft lower frame 2 and the soft upper frame 3 can be compressed to faun a flat shape (for example, a circular compression to form a flat shape), thereby reducing its volume, so that more products can be placed in the same area, and reduce the packaging costs and transporting costs. In addition, because the soft material has better sealing effect, the soft lower frame 2 and the soft upper frame 3 have sealing effect, can replace the sealing parts and simplify the installation structure.

In embodiments of the present invention, the cylindrical filter element body 1 is folded by a sheet of filter sheet, a plurality of folding edges 11 are formed on the cylindrical filter element body 1, and the plurality of the folding edges 11 are arranged along the central axial direction of the cylindrical filter element body 1; the cylindrical filter element body 1 can be folded along the folding edges 11 to reduce the hollow structure 14.

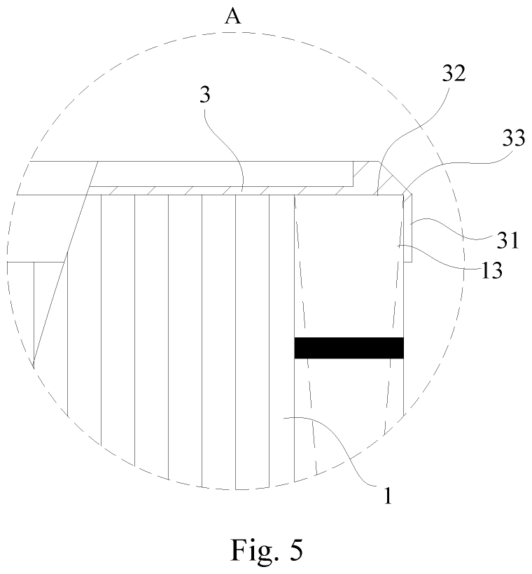

In embodiments of the present invention, referring to FIG. 5, an upper containing groove 32 is arranged along the circumferential edge of the soft upper frame 3, the upper containing groove 32 is provided with a first peripheral edge 33, the first peripheral edge 33 is provided with an upper wrapping edge 31, the upper edge 13 is embedded in the upper containing groove 32, and the upper edge 13 is at least wrapped in the upper wrapping edge 31, which can better restrain the upper edge 13 of the cylindrical filter element body 1, thereby improving the structural stability of the soft frame filter element, and making it more durable,

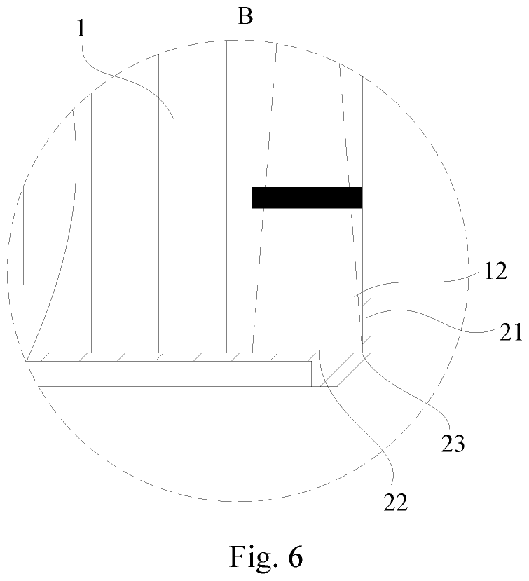

In embodiments of the present invention, referring to FIG. 6, a lower containing groove 22 is arranged along the circumferential edge of the soft lower frame 2, the lower containing groove 22 is provided with a second peripheral edge 23, the second peripheral edge 23 is provided with a lower wrapping edge 21, the lower edge 12 is embedded in the lower containing groove 22, and the lower edge 12 is at least wrapped in the lower wrapping edge 21, which can better restrain the lower edge 12 of the cylindrical filter element body 1, improving the structural stability of the soft frame filter element, and making it more durable.

In embodiments of the present invention, the cylindrical filter element body 1 is in a cylindrical shape or in an elliptical cylinder shape. The above shapes can be flattened into a regular shape, which is conducive to packaging and transporting.

In embodiments of the present invention, the soft lower frame 2 and/or the soft upper frame 3 are made from foamed polyurethane material . The polyurethane foaming, material is soft, easy to process, easy to form and has a certain sealing effect, which can replace sealing elements.

In embodiments of the present invention, a preparing method of the above soft frame filter element includes the following steps:

S1. preparing the cylindrical filter element body 1: folding a sheet of filter sheet into an annular cylindrical filter element body 1; placing the lower edge 12 of the cylindrical filter element body 1 in a lower mold and placing the upper edge 13 of the cylindrical filter element body 1 in an upper mold;

S2. preparing soft lower frame 2 and soft upper frame 3: injecting the polyurethane raw material into the upper mold and the lower mold, the soft lower frame 2 and the soft upper frame 3 are made respectively after foaming the polyurethane raw material;

S3. preparing soft frame filter element: combining the soft lower frame 2 with the lower edge 12 of the cylindrical filter element body 1, and combining the soft upper frame 3 with the upper edge 13 of the cylindrical filter element body 1, and the soft frame filter element is, obtained.

In embodiments of the present invention, the polyurethane raw material contains the following mass percentages of components: 38%-42% of isocyanate, 13%-17% of diethanolamine, 6%-8% of crosslinking agent, 2%-4% of silicone foam stabilizer and 34%-36% of triethylene diamine.

In embodiments of the present invention, the polyurethane raw material contains the following mass percentages of components: 39%-41% of isocyanate, 14%-16% of diethanolamme, 6%-8% of crosslinking agent, 2%-4% of silicone foam stabilizer and 34%-36% of triethylene diamine. The soft lower frame 2 and the soft upper frame 3 made of the above materials have good resilience, which can be easily folded and play a good supporting role when unfolded. It is not easy to deform and will not crack, deformation, fracture and other situations when used for a long time.

In order to further understand the invention, the preferred embodiments of the invention are described below in combination with the embodiments, but it should be understood that these descriptions are only for further explaining the features and advantages of the invention, rather than limiting the claims of the invention. The raw materials used in the embodiments of the invention are obtained through commercial purchase.

Examples 1-5

The raw materials and their dosage of examples 1-5 are shown in Table 1:

TABLE 1

| | 1 | 2 | 3 | 4 | 5 |
|---|---|---|---|---|---|
| Isocyanate (kg) | 38 | 39 | 40 | 41 | 42 |
| Diethanolamine (kg) | 17 | 16 | 15 | 14 | 13 |
| crosslinking agent (kg) | 6 | 7 | 7 | 8 | 6 |
| silicone foam stabilizer (kg) | 3 | 4 | 3 | 2 | 4 |
| triethylene diamine (kg) | 36 | 34 | 35 | 35 | 35 |

The preparing method of the soft frame filter element in examples 1-5 includes the following steps:

S1. preparing the cylindrical filter element body 1: folding a sheet of filter sheet into an annular cylindrical filter element body 1; placing the lower edge 12 of the cylindrical filter element body 1 in a lower mold and placing the upper edge 13 of the cylindrical filter element body 1 in an upper mold;

S2. preparing soft lower frame 2 and soft upper frame 3: injecting the polyurethane raw material into the upper mold and the lower mold, the soft lower frame 2 and the soft upper frame 3 are made respectively after foaming the polyurethane raw material;

S3. preparing soft frame filter element: combining the soft lower frame 2 with the lower edge 12 of the cylindrical filter element body 1, and combining the soft upper frame 3 with the upper edge 13 of the cylindrical filter element body 1, and the soft frame filter element is obtained.

The above is only better embodiments in the invention and is not used to limit the invention. Any modification, equivalent replacement and improvement made within the spirit and principles of the invention shall be included in the protection of the invention.

1. A soft frame filter element, wherein comprising:
a cylindrical filter element body, having a lower edge and an upper edge, and a hollow structure is formed in a center of said cylindrical filter element body;
a soft lower frame, wrapping said lower edge; and
a soft upper frame, wrapping said upper edge; said soft lower frame and said soft upper frame can be compressed to reduce a volume of said hollow structure.

2. The soft frame filter element according to claim 1, wherein said cylindrical filter element body is folded by a sheet of filter sheet, a plurality of folding edges are formed on said cylindrical filter element body, and said folding edges are arranged along a central axial direction of said cylindrical filter element body; said cylindrical filter element body can be folded along said folding edges to reduce said volume of said hollow structure.

3. The soft frame filter element according to claim 1, wherein an upper containing groove is arranged along a circumferential edge of said soft upper frame, said upper containing groove is provided with a first peripheral edge with an upper wrapping edge, said upper edge is embedded in said upper containing groove, and said upper edge is at least wrapped in said upper wrapping edge.

4. The soft frame filter element according to claim 1, wherein a lower containing groove is arranged along a circumferential edge of said soft lower frame, said lower containing groove is provided with a second peripheral edge with a lower wrapping edge, said lower edge is embedded in said lower containing groove, and said lower edge is at least wrapped in said lower wrapping edge.

5. The soft frame filter element according to claim 1, wherein said cylindrical filter element body is in a cylindrical shape or in an elliptical cylinder shape.

6. The soft frame filter element according to claim 2, wherein said cylindrical filter element body is in a cylindrical shape or in an elliptical cylinder shape.

7. The soft frame filter element according to claim 3, wherein said cylindrical filter element body is in a cylindrical shape or in an elliptical cylinder shape.

8. The soft frame filter element according to claim 4, wherein said cylindrical filter element body is in a cylindrical shape or in an elliptical cylinder shape.

9. The soft frame filter element according to claim 1, wherein said soft lower frame and/or the soft upper frame are foamed polyurethane frames.

10. The soft frame filter element according to claim 2, wherein said soft lower frame and/or the soft upper frame are foamed polyurethane frames.

11. The soft frame filter element according to claim 3, wherein said soft lower frame and/or the soft upper frame are foamed polyurethane frames.

12. The soft frame filter element according to claim 4, wherein said soft, lower frame and/or the soft upper frame are foamed polyurethane frames.

13. A preparing method of said soft frame filter element according to claim 1, wherein comprising following steps:
S1. preparing said cylindrical filter element body folding a sheet of filter sheet into an annular cylindrical filter element body; placing said lower edge of said cylindrical filter element body in a lower mold and placing said upper edge of said cylindrical filter element body in an, upper mold;
S2. preparing soft lower frame and soft upper frame: injecting polyurethane raw material into said upper mold and said lower mold, said soft lower frame and said soft upper frame are made respectively after foaming said polyurethane raw material;
S3. preparing soft frame filter element: combining said soft lower frame with said lower edge of said cylindrical filter element body, and combining said soft upper frame with said upper edge of said cylindrical filter element body, and said soft frame filter element is obtained.

14. The preparing method of said soft frame filter element according to claim 13, wherein said polyurethane raw material contains following mass percentages of components: 38%-42% of isocyanate, 13%-17% of diethanolamine, 6%-8% of crosslinking agent, 2%-4% of silicone foam stabilizer and 34%-36% of triethylene diamine.

15. The preparing method of the soft frame filter element according to claim 13, wherein said polyurethane raw material contains following mass percentages of components: 39%-41% of isocyanate, 14% 46% of diethanolamine, 6%-8% of crosslinking agent, 2%-4% of silicone foam stabilizer and 34%-36% of triethylene diamine.
